(19) United States
(12) Patent Application Publication
(10) Pub. No.: US 2014/0357800 A1
(43) Pub. Date: Dec. 4, 2014

(54) Treatment Of Carbon Based Filler

(71) Applicant: Dow Corning Corporation, MIDLAND, MI (US)

(72) Inventors: Mihael Wolfgang Backer, Mainz (DE); Thomas Chaussee, Fontaines Saint Martin (FR); Olivier Debever, Lembeek (BE); Francois De Buyl, Hoeilaart (BE)

(21) Appl. No.: 14/362,686

(22) PCT Filed: Dec. 7, 2012
(86) PCT No.: PCT/EP12/74734

§ 371 Date: Jun. 4, 2014

(30) Foreign Application Priority Data
Dec. 8, 2011 (GB) 1121125.7

(51) Int. Cl. C08F 30/08; C08F 8/32

(52) U.S. Cl. CPC C08F 30/08; C08F 8/32
USPC 525/326.5; 525/375; 544/398

(57) ABSTRACT

This invention relates to the treatment of carbon based fillers with amines, including piperazines and aziridines, to modify the surface of the filler.

This invention relates to the treatment of carbon based fillers with amines, including piperazines and aziridines, to modify the surface of the filler.

Examples of carbon based fillers include carbon black, which is used as a reinforcing filler in many polymer and rubber compositions, and carbon fibre, which is also used in reinforcing polymer compositions, particularly to give directional reinforcement.

Further carbon based fillers include carbon nanotubes, graphene, expandable graphene and expandable graphite. Treatment of such carbon based fillers with amines according to the invention improves the adhesion of the fillers to organic polymers.

Carbon based fillers like carbon fibres can be used for example to replace heavier glass fibres providing same strength enhancement at a lighter weight.

EP0456465 describes 1,4-diaminopiperazine hydrochloride.

EP0372344 describes an inorganic fibre such as carbon fibre modified by a surface treatment with a dinitrodiamine compound.

WO2011/082064 describes chelating agent modified graphene oxides having the following formula G(AB)x; wherein G is graphene oxide, A is selected from the group consisting of —(CH₂)ₘ—, —NH—, —S—, —O—Sᵢ(—OR¹)₂(—CH₂)ₘ—, —C(═O)—, —C(═O)—O—, —C(═O)—O(CH₂)ₘ—, —C(═O)—NH—, —C(═O)—NH—(CH₂)ₘ—, —P(═O)₂—O—, wherein m is 1-12 and R¹ is H, or C₁-C₁₂ alkyl; and B is a chelating moiety; wherein the ratio of basic graphene oxide units:x is from about 1:0.00001 to about 1:0.5.

WO 01/70866 describes a coupler for use in carbon black filled rubber compositions. The coupler includes an amine group and a thiol group or a polysulfidic linkage.

A process according to one aspect of the invention for modifying the surface of a carbon based filler is characterised in that the carbon based filler is treated with a compound (I) containing in its molecule at least two moieties of the formula

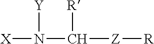

wherein X represents a hydrocarbyl or substituted hydrocarbyl group having 1 to 20 carbon atoms; Y represents hydrogen or a hydrocarbyl or substituted hydrocarbyl group having 1 to 20 carbon atoms; R′ represents hydrogen or a hydrocarbyl or substituted hydrocarbyl group having 1 to 20 carbon atoms; Z represents oxygen or sulphur; and R represents a hydrocarbyl or substituted hydrocarbyl group having 1 to 20 carbon atoms, at least one of the groups X and R being a multivalent substituted hydrocarbyl group linking two or more

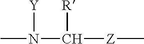

moieties.

A process according to another aspect of the invention for modifying the surface of a carbon based filler is characterised in that the carbon based filler is treated with a compound (II) containing in its molecule at least two moieties of the formula —OC(O)—(Az)-J wherein Az represents an aziridine ring bonded to the group J through its nitrogen atom; and J represents a hydrocarbyl or substituted hydrocarbyl group having 1 to 20 carbon atoms.

The amine compounds (I) of the invention, including the substituted piperazines, are capable of bonding strongly to materials containing carbon-to-carbon unsaturation. Carbon based fillers such as carbon fibre, carbon black, carbon nanotubes, graphene, expandable graphene and expandable graphite generally contain some carbon-to-carbon unsaturation. We believe that upon heating, for example to the temperatures and under the processing conditions used for producing filled polymer compositions, the etheramine moiety of (I) forms a very reactive species which reacts with the C═C bonds present in the polymeric material through [2+3] cycloaddition.

Similarly the aziridine compounds (II) as defined above are capable of bonding strongly to polymeric materials containing carbon-to-carbon unsaturation, including carbon based fillers such as carbon fibre, carbon black, carbon nanotubes, graphene, expandable graphene and expandable graphite at the temperatures and under the processing conditions used for producing filled polymer compositions, reacting through the aziridine ring which reacts with C═C bonds of the elastomer through cycloaddition.

Thus in one process according to the invention the polymeric material, the carbon-based filler and the amine compound (I) or (II) are heated together preferably at a temperature of 120 to 200° C., whereby the polymeric material is crosslinked by the substituted piperazine. Such in-situ process permits to form in one step the composite material containing the modified filler and the polymer matrix.

In an alternative process according to the invention the polymeric material and the amine compound (I) or (II) are mixed at a temperature of 0 to 120° C. and subsequently heated at a temperature of 120 to 200° C. to crosslink the polymeric material. When mixing at an elevated temperature below 120° C., there may be some modification of the polymeric material which can be detected via infra-red spectroscopy, for example at least some of the amine compound (I) or (II) may be bonded to the polymeric material without substantial crosslinking.

Any of the molecules of the present invention can be used as crosslinker of polymers. It can replace peroxide curing system or sulfur cure system.
For sulfur curing system replacement: This crosslinking system could be used to improve curing time of rubber goods allowing a better and more homogeneous crosslinking and for example in tyre lead to a more homogeneous cure through the all tyre composition, it is known for those skilled in the art that base-tread layers needs to be more accelerated to be cured in the same time (within a full tyre) as the top-tread layer.
For peroxide curing this system offers a better handling, avoid use of peroxide, leading to similar curing properties

Polymers that could be crosslinked are diene elastomers, any polymer containing vinyl pending or end group. For example: EPDM, vinyl-functional PDMS, SBR, BR, IR, IIR, NR.

In the compound (I), the groups X and Y can both be substituted hydrocarbyl groups linking the same two

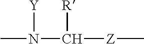

moieties to form a piperazine ring. The compound of formula (I) can thus be a substituted piperazine of the formula [R—Z—(CHR′-Pip-CHR′—Z—R″—Z)ₙ—CH2-Pip-CH2-Z]ₘ—R* where each R represents a hydrocarbyl or substituted hydrocarbyl group having 1 to 20 carbon atoms; each R′ represents hydrogen or a hydrocarbyl or substituted hydrocarbyl group having 1 to 8 carbon atoms; Pip represents an optionally substituted piperazine ring bonded through its nitrogen atoms; each Z represents an oxygen or sulphur atom; R″ represents an alkylene, hydroxyalkylene, thioalkylene or polyoxyalkylene linkage having 2 to 20 carbon atoms or an alkylene, hydroxyalkylene, thioalkylene or polyoxyalkylene linkage having 2 to 20 carbon atoms substituted by 1 to 4 R—Z-CHR′-Pip-CHR′-Z— groups, where R, R′, Z and Pip are defined as above; n=0 to 20; m=1 to 6; and R* is the residue of an alcohol, thiol, polyol or polythiol having at least m hydroxyl or thiol groups.

In one preferred type of substituted piperazine of the formula [R—Z—(CHR′-Pip-CHR′-Z—R″—Z)ₙ—CH2-Pip-CH2-Z]ₘ—R* used for modifying a polymeric material containing carbon-to-carbon unsaturation, n=0, m=1, and each atom Z in the substituted piperazine represents an oxygen atom, that is the substituted piperazine has the formula R—O—CHR′-Pip-CHR′—O—R, in which each R represents a hydrocarbyl or substituted hydrocarbyl group having 1 to 20 carbon atoms.

Such a substituted piperazine with the formula R—O—CHR′-Pip-CHR′—O—R can be prepared by reacting a piperazine with an aldehyde of the formula R′CHO and an alcohol of the formula ROH.

In the substituted piperazine of the formula R—O—CHR′-Pip-CHR′—O—R , each group R preferably represents a hydrocarbyl group having 1 to 8 carbon atoms, for example an alkyl group such as an ethyl, methyl, butyl, hexyl or 2-ethylhexyl, an aryl group such as phenyl or an aralkyl group such as benzyl. Most preferably each R represents an ethyl group. The alcohol ROH may be released as the substituted piperazine reacts with the carbon based filler, and ethanol is the most environmentally friendly compound among the alcohols.

The aldehyde which is reacted with the piperazine and the alcohol is preferably formaldehyde to form a substituted piperazine of the formula R—O—CH₂-Pip-CH₂—O—R, although other aldehydes such as acetaldehyde can be used. The piperazine reagent is preferably unsubstituted at the 2-, 3-, 5- and 6-positions, although the piperazine ring can alternatively be substituted in any or all of the 2-, 3-, 5-, or 6-positions by a substituent which does not react with an aldehyde or an alcohol such as an alkyl substituent, for example by one or more methyl groups.

For the substituted piperazines of the formula [R—Z—(CHR′-Pip-CHR′—Z—R″—Z)ₙ—CH2-Pip-CH2-Z]ₘ—R* in which n=0 and m=1, it is preferred that each atom Z in the substituted piperazine represents an oxygen atom rather than a sulphur atom, to avoid release of a volatile thiol on crosslinking.

Each piperazine ring of the novel substituted piperazines of the formula [R—Z—(CHR′-Pip-CHR′—Z—R″—Z)ₙ—CH2-Pip-CH2-Z]ₘ—R*, where m=2 to 6 alternatively 1 to 6 and R* is the residue of a polyol or polythiol having at least m hydroxyl or thiol groups is preferably unsubstituted at the 2-, 3-, 5- and 6-positions, although the piperazine ring can alternatively be substituted in any or all of the 2-, 3-, 5-, or 6-positions by a substituent which does not react with an aldehyde or an alcohol such as an alkyl substituent. Preferred substituted piperazines of the formula [R—Z—(CHR′-Pip-CHR′—Z—R″—Z)ₙ—CH2-Pip-CH2-Z]ₘ—R*, where m=2 to 6 and R′ is the residue of a polyol or polythiol having at least m hydroxyl or thiol groups thus have the formula

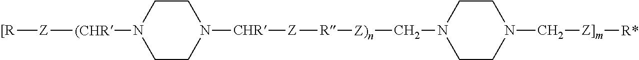

where R, Z, R′, R″, R*, n and m are defined as above.

Examples of polyols which can be reacted with an aldehyde, for example formaldehyde, and piperazine include diols such as ethylene glycol, di- and tri-ethylene glycol and polyethyleneglycol of varying chain lengths, propyleneglycol, di- and tripropyleneglycol and polypropyleneglycol of varying chain lengths, butane-1,3-diol and butane-1,4-diol, neopentyl glycol, hexane-1,6-diol, isosorbide, 1,4-cyclohexanedimethanol, bisphenol-A, hydroquinone or resorcinol lengthened with ethylene oxide and propylene oxide; triols such as trimethylolpropane, glycerol, trimethylolethane, 2-hydroxymethylbutane-1,4-diol, any of which can be lengthened with ethylene oxide or propylene oxide., and higher polyols such as pentaerythritol and di-pentaerythritol.

The piperazine and the aldehyde can if desired be reacted with a mixture of a polyol of the formula R*(OH)_{z} where R* is the residue of a polyol having z hydroxyl groups, where z=2 to 6, and an alcohol of the formula ROH, where R represents a hydrocarbyl group having 1 to 20 carbon atoms, to form a substituted piperazine of the formula

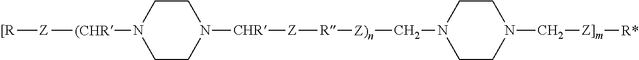

where z is greater than or equal to m.

Alternatively the compound (I) can be a compound containing in its molecule at least two moieties of the formula

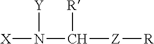

wherein X represents a multivalent substituted hydrocarbyl group linking two or more

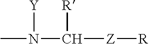

groups; Y represents a hydrocarbyl or substituted hydrocarbyl group having 1 to 20 carbon atoms; Z represents oxygen; and none of Y, R and R′ is a multivalent substituted hydrocarbyl group linking two or more

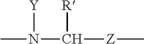

moieties.

The compound (I) may for example have the formula

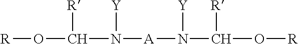

wherein each Y represents a hydrocarbyl or substituted hydrocarbyl group having 1 to 20 carbon atoms; each R′ represents hydrogen or a hydrocarbyl or substituted hydrocarbyl group having 1 to 20 carbon atoms; each R represents a hydrocarbyl or substituted hydrocarbyl group having 1 to 20 carbon atoms, and none of Y, R and R′ is a multivalent substituted hydrocarbyl group linking two or more

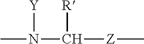

moieties; and A represents a divalent group. A may for example represent a divalent organic group having 2 to 20 carbon atoms, for example an alkylene group.

An alternative preferred divalent group A is a metal carboxylate group of the formula

M(-O—C(═O)-A′)ₘ

wherein each A′ represents an alkylene group having 1 to 6 carbon atoms; and M represents a metal ion of valence m, preferably m=2. The compound (I) may thus be of the formula

M(-O—C(═O0-A′-N(Y)—CH(R′)—O—R)ₘ. Preferably, when m=2

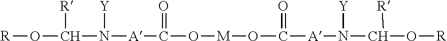

wherein Y represents a hydrocarbyl or substituted hydrocarbyl group having 1 to 20 carbon atoms; each R′ represents hydrogen or a hydrocarbyl or substituted hydrocarbyl group having 1 to 20 carbon atoms; each R represents a hydrocarbyl or substituted hydrocarbyl group having 1 to 20 carbon atoms, and none of Y, R and R′ is a multivalent substituted hydrocarbyl group linking two or more

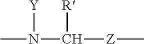

moieties.

A preferred divalent metal M is zinc. Alternative divalent metals include magnesium, copper and iron:

The compound of the formula

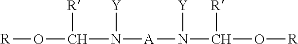

can in general be prepared by reacting a diamine of the formula Y—NH-A-NH—Y, where A represents a divalent group and Y represents a hydrocarbyl or substituted hydrocarbyl group having 1 to 20 carbon atoms, with an aldehyde of the formula R′CHO, where R′ represents hydrogen or a hydrocarbyl or substituted hydrocarbyl group having 1 to 20 carbon atoms, and an alcohol of the formula ROH where R represents a hydrocarbyl or substituted hydrocarbyl group having 1 to 20 carbon atoms, none of Y, R and R′ being a multivalent substituted hydrocarbyl group linking two or more

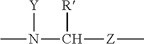

moieties.

One example of a preferred zinc carboxylate according to the invention has the formula

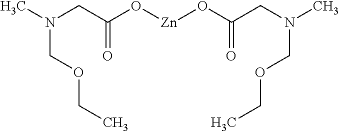

This zinc carboxylate can be prepared by the reaction of a zinc amino acid carboxylate of the formula (CH₃—NH—CH₂—COO)₂Zn with formaldehyde and ethanol.

The aziridine compound (II) contains in its molecule at least two moieties of the formula —OC(O)-(Az)-J wherein Az represents an aziridine ring bonded to the group J through its nitrogen atom; and J represents a hydrocarbyl or substituted hydrocarbyl group having 1 to 20 carbon atoms. The compound (II) can in general be prepared by reacting a 2,3-dibromopropionate containing in its molecule at least two moieties of the formula —OC(O)—CHBr—CH₂Br with an amine of the formula J-NH₂.

The 2,3-dibromopropionates containing at least two moieties of the formula —OC(O)—CHBr—CH₂Br can be prepared by the reaction of an acrylate containing at least two acrylate groups of the formula —OC(O)—CH═CH₂ with bromine at ambient temperature or below.

The compound (II) can for example be of the formula Q(-OC(O)-(Az)-J)ₓ wherein x=2 to 6; and Q is the residue of a polyol having at least x hydroxyl groups. Such an aziridine compound (II) can be prepared by reacting a polyol 2,3-dibromopropionate ester of the formula Q(-OC(O)—CHBr—CH₂Br)ₓ wherein x=1 to 6 and Q is the residue of a polyol having at least x hydroxyl groups with an amine of the formula J-NH₂ wherein J represents a hydrocarbyl or substituted hydrocarbyl group having 1 to 20 carbon atoms. The polyol 2,3-dibromopropionate ester can be prepared from a polyol polyacrylate by reaction with bromine.

Examples of polyol polyacrylates that can be brominated and reacted with an alkoxysilylalkylamine include diacrylates such as ethyleneglycol diacrylate, di- and triethyleneglycol diacrylates and polyethyleneglycol diacrylates of varying chain lengths, propyleneglycol diacrylate, di- and tripropyleneglycol diacrylate and polypropyleneglycol diacrylates of varying chain lengths, butanediol-1,3- and -1,4-diacrylates, neopentylglycol diacrylate, hexanediol-1,6-diacrylate, isosorbide diacrylate, 1,4-cyclohexanedimethanol diacrylate, bisphenol-A-diacrylate and the diacrylates of hydroquinone, resorcinol lengthened with ethylene oxide and propylene oxide, triacrylates such as trimethylolpropane triacrylate, glycerol triacrylate, trimethylolethane triacrylate, 2-hydroxymethylbutanediol-1,4-triacrylate, and the triacrylates of glycerol, trimethylolethane or trimethylolpropane lengthened with ethylene oxide- or propylene oxide, and higher polyol acrylates such as pentaerythritol tetraacrylate and di-pentaerythritol hexaacrylate.

One example of a preferred compound (II) of the formula Q(-OC(O)-(Az)-J)ₓ has the formula

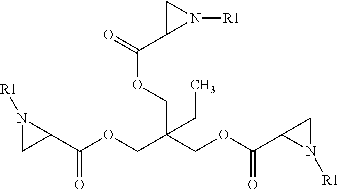

wherein R1 represents an alkyl group having 1 to 6 carbon atoms. This can be prepared by the reaction of trimethylolpropane triacrylate with bromine, and reacting the 2,3-dibromopropionate ester produced with an alkylamine.

The aziridine compound (II) can alternatively be a metal carboxylate of the formula M(-OC(O)-(Az)-J)m wherein M represents a metal ion of valence m; Az represents an aziridine ring bonded to the group J through its nitrogen atom; and J represents a hydrocarbyl or substituted hydrocarbyl group having 1 to 20 carbon atoms. Such an aziridine metal carboxylate compound (II) can be prepared by reacting a metal 2,3-dibromopropionate salt of the formula M(-OC(O)—CHBr—CH₂Br)₂ wherein M represents a metal ion of valence m, with an amine of the formula J-NH₂ wherein J represents a hydrocarbyl or substituted hydrocarbyl group having 1 to 20 carbon atoms. The metal 2,3-dibromopropionate salt of the formula M(-OC(O)—CHBr—CH₂Br)₂ can be prepared from the corresponding metal diacrylate by reaction with bromine.

A preferred divalent metal M is zinc. Alternative divalent metals include magnesium, copper and iron. One example of a preferred aziridine metal carboxylate compound (II) has the formula

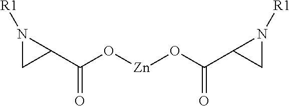

wherein R1 represents an alkyl group having 1 to 6 carbon atoms. This can be prepared by reacting zinc diacrylate with bromine, and reacting the zinc di(2,3-dibromopropionate) produced with an alkylamine.

The carbon based filler which is treated with the amine compound (I) or (II) can for example be carbon fibre, carbon black, carbon nanotubes, graphene, expandable graphene and expandable graphite. The amine compound (I) or (II) is generally contacted with the carbon based filler when in a liquid form. The carbon based filler is preferably treated with the amine compound (I) or (II) at a temperature in the range 110° C. to 190° C. Most of the amine compounds (I) or (II) described above are liquid at the preferred temperature of treatment. These liquid hydrolysable silanes can be applied undiluted or in the form of a solution or emulsion. An amine compound (I) or (II) which is solid at the temperature of treatment is applied in the form of a solution or emulsion.

Various types of equipment can be used to treat the carbon based filler with the hydrolysable silane. Suitable types will depend on the form of the carbon based filler. For a particulate filler such as carbon black, a mixer can be used such as a Banbury mixer, a Brabender Plastograph (Trade Mark) 350S mixer, a pin mixer, a paddle mixer such as a twin counter-rotating paddle mixer, a Glatt granulator, a Lodige equipment for filler treatment, a ploughshare mixer or an intensive mixer including a high shear mixing arm within a rotating cylindrical vessel. A fibrous filler such as carbon fibre can be treated in tow, yarn, tyre cord, cut fibre or fabric form using an appropriate process known in the textile industry, for example a tow, yarn or fabric can be treated by spraying, gravure coating, bar coating, roller coating such as lick roller, 2-roll mill, dip coating or knife-over-roller coating, knife-over-air coating, padding or screen-printing.

The carbon based filler modified by treatment with the amine compound (I) or (II) can be used in various polymer compositions. This filler treatment creates a coupling agent between the filler and the polymer matrix containing a vinyl group. For example a filled polymer composition comprising a thermoplastic resin, a thermoset resin or an elastomer shows improved adhesion and/or coupling of the carbon based filler to the polymeric material if the carbon based filler is modified by treatment with the amine compound (I) or (II). This can ensure creation of an intimate network between the carbon based filler and the polymer matrix wherein the filler is dispersed. A better coupling between the filler and the polymer matrix gives better reinforcing properties and can also give better thermal and electrical conductivity.

Examples of thermoplastic resins include organic polymers such as hydrocarbon polymers like for example polyethylene or polypropylene, fluorohydrocarbon polymers like Teflon, silane modified hydrocarbon polymers, maleic anhydride modified hydrocarbon polymers, vinyl polymers, acrylic polymers, polyesters, polyamides and polyurethanes.

When producing a filled thermoset resin composition, the modified carbon based filler is generally compounded with the thermosetting resin before the resin is cured. Examples of thermosetting resins include epoxy resins, polyurethanes, amino-formaldehyde resins and phenolic resins. Thermosetting resins may include aminosilane as curing agent.

The modified carbon filler can also be used in silicone polymers or in polymers containing silyl groups. For example it can be used in silicone elastomers, silicone rubbers, resins, sealants, adhesives, coatings, vinyl functionalised PDMS (with terminal or pendant Si-vinyl groups). A wide range of applications of such silicone based materials exist for example in electronics, for managing thermal and electrical properties like for example conductivity. It can further be used in silicone-organic copolymers like for example silicone polyethers or in silyl-modified organic polymers with terminated or pendant silyl group, silanol functional PDMS (with terminal and/or pendant silanol groups), and silyl-alkoxy functional PDMS (with terminal and/or pendant silyl groups). This includes any type of silyl terminated polymers like polyether, polyurethane, acrylate, polyisobutylene, grafted polyolefin etc. For example a silicone elastomer can contain modified carbon nanotubes to form a composite coating on metal having improved thermal properties.

The modified carbon based filler can be dispersed in an elastomer like a diene elastomer i.e. a polymer having elastic properties at room temperature, mixing temperature or at the usage temperature, which can be polymerized from a diene monomer. Typically, a diene elastomer is a polymer containing at least one ene (carbon-carbon double bond, C═C) having a hydrogen atom on the alpha carbon next to the C═C bond. The diene elastomer can be a natural polymer such as natural rubber or can be a synthetic polymer derived at least in part from a diene. The diene elastomer can for example be:
(a) any homopolymer obtained by polymerization of a conjugated diene monomer having 4 to 12 carbon atoms;
(b) any copolymer obtained by copolymerization of one or more dienes conjugated together or with one or more vinyl aromatic compounds having 8 to 20 carbon atoms;
(c) a ternary copolymer obtained by copolymerization of ethylene, of an [alpha]-olefin having 3 to 6 carbon atoms with a non-conjugated diene monomer having 6 to 12 carbon atoms, such as, for example, the elastomers obtained from ethylene, from propylene with a non-conjugated diene monomer of the aforementioned type, such as in particular 1,4-hexadiene, ethylidene norbornene or dicyclopentadiene;
(d) a copolymer of isobutene and isoprene (butyl rubber), and also the halogenated, in particular chlorinated or brominated, versions of this type of copolymer.

Suitable conjugated dienes are, in particular, 1,3-butadiene, 2-methyl-1,3-butadiene, 2,3-di(C₁-C₅ alkyl)-1,3-butadienes such as, for instance, 2,3-dimethyl-1,3-butadiene, 2,3-diethyl-1,3-butadiene, 2-methyl-3-ethyl-1,3-butadiene, 2-methyl-3-isopropyl-1,3-butadiene, an aryl-1,3-butadiene, 1,3-pentadiene and 2,4-hexadiene. Suitable vinyl-aromatic compounds are, for example, styrene, ortho-, meta- and para-methylstyrene, the commercial mixture “vinyltoluene”, para-tert.-butylstyrene, methoxystyrenes, chlorostyrenes, vinylmesitylene, divinylbenzene and vinylnaphthalene.

Coupling systems in, for example a dienic elastomer, are able to limit energy dissipation linked to the filler, and improve its dispersion to improve the following properties:
Filler dispersion improvement to reach higher reinforcement, or same reinforcement at lower filler loading. This for tyre will improve Tread wear.
Limit of energy dissipation by loosing polymer/filler interaction under shear, this for example improves the rolling resistance of a tyre made with the invention.
Improve thermal conductivity of so made rubber compounds. This can, for example, improve curing of base-tread layer if all tread or top-tread is made with this composition.
Lead to lighter weight tyre If this technology is used to replace silica, it is known for those skilled in art that graphene, or carbon nanotubes can lead to same reinforcement at lower volume fraction, in addition the filler is 30% lighter if using Carbon black than silica consequently reducing the weight of the tyre made using this composition.

The rubber and coupling system may be used in Tyres, Flame retardancy using NR compounds, shoe sole, hoses, belts, and other rubber goods.

The carbon based filler modified by treatment with the amine compound (I) or (II) shows particularly good adhesion to polymeric materials containing carbon-to-carbon unsaturation. Examples of such polymeric materials include diene elastomers, for example natural rubber or a synthetic homopolymer or copolymer of a diene monomer, and organopolysiloxanes containing alkenyl groups such as vinyl groups.

The amine compounds (I) and (II) are also capable of modifying polymeric materials containing carbon-to-carbon unsaturation. Especially good adhesion may be achieved if a carbon based filler modified by treatment with the amine compound (I) or (II) is compounded with a polymeric material containing carbon-to-carbon unsaturation modified by treatment with the amine compound (I) or (II).

Filled polymer compositions comprising a carbon based filler modified by treatment with the amine compound (I) or (II) show improved physical properties. Examples of the physical properties that can be improved include thermal conductivity & thus heat dissipation, flame retardancy, mechanical properties such as tensile strength obtained by reinforcement, reduction of crack failure at the polymer/filler interface, electrical conductivity and thermal stability. For example the improved electrical conductivity is of advantage in polymer compositions used in electronic devices and solar cells. The carbon based filler modified by treatment with the amine compound (I) or (II) can be used as a reinforcing filler of light weight.

The carbon based filler modified by treatment with the amine compound (I) or (II) can be used in conjunction with other fillers or fibres in a filled polymer composition. Such other fillers can be any type of filler or fibre, synthetic or natural, and can for example include glass fibres, wood fibres or silica, or bio-fillers like starch, cellulose including cellulose nanowhiskers, hemp, talc, polyester, polypropylene, polyamide etc. The mixture of fillers can be used in a thermoplastic resin, a thermoset resin or an elastomer as described above. A mixture of carbon based filler modified by treatment with the amine compound (I) or (II) and a glass fibre filler can for example be used in a filled polymer composition for forming wind turbine blades.

The invention provides a process for modifying the surface of a carbon based filler, characterised in that the carbon based filler is treated with a compound (I) containing in its molecule at least two moieties of the formula

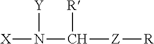

wherein X represents a hydrocarbyl or substituted hydrocarbyl group having 1 to 20 carbon atoms; Y represents hydrogen or a hydrocarbyl or substituted hydrocarbyl group having 1 to 20 carbon atoms; R′ represents hydrogen or a hydrocarbyl or substituted hydrocarbyl group having 1 to 20 carbon atoms; Z represents oxygen or sulphur; and R represents a hydrocarbyl or substituted hydrocarbyl group having 1 to 20 carbon atoms, at least one of the groups X and R being a multivalent substituted hydrocarbyl group linking two or more

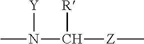

Moieties, or with a compound (II) containing in its molecule at least two moieties of the formula —OC(O)-(Az)-J wherein Az represents an aziridine ring bonded to the group J through its nitrogen atom; and J represents a hydrocarbyl or substituted hydrocarbyl group having 1 to 20 carbon atoms.

The invention provides a process characterised in that the groups X and Y are both substituted hydrocarbyl groups linking the same two

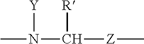

moieties to form a piperazine ring.

Preferably, the compound (I) is a substituted piperazine of the formula [R—Z—(CHR′-Pip-CHR′-Z—R″—Z)ₙ—CH2-Pip-CH2-Z]ₘ—R*, where each R represents a hydrocarbyl or substituted hydrocarbyl group having 1 to 20 carbon atoms; each R′ represents hydrogen or a hydrocarbyl or substituted hydrocarbyl group having 1 to 8 carbon atoms; Pip represents an optionally substituted piperazine ring bonded through its nitrogen atoms; each Z represents an oxygen or sulphur atom; R″ represents an alkylene, hydroxyalkylene, thioalkylene or polyoxyalkylene linkage having 2 to 20 carbon atoms or an alkylene, hydroxyalkylene, thioalkylene or polyoxyalkylene linkage having 2 to 20 carbon atoms substituted by 1 to 4 R—Z—CHR′-Pip-CHR′—Z— groups, where R, R′, Z and Pip are defined as above; n=0 to 20; m=1 to 6; and R* is the residue of an alcohol, thiol, polyol or polythiol having at least m hydroxyl or thiol groups.

Preferably, n=0, m=1, each atom Z in the substituted piperazine represents an oxygen atom and each group R represents a hydrocarbyl group having 1 to 8 carbon atoms.

Preferably, R* represents the residue of a polyol selected from ethylene glycol, propylene glycol, 1,4-butanediol, trimethylolpropane and pentaerythritol.

Preferably, X represents a multivalent substituted hydrocarbyl group linking two or more

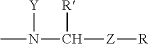

groups; Y represents a hydrocarbyl or substituted hydrocarbyl group having 1 to 20 carbon atoms; Z represents oxygen; and none of Y, R and R′ is a multivalent substituted hydrocarbyl group linking two or more

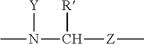

moieties.

Preferably, the compound (I) has the formula

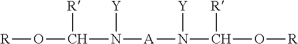

wherein each R, R′ and Y is defined as in claim 7 and A represents a divalent organic group having 2 to 20 carbon atoms.

Preferably, the compound (I) has the formula

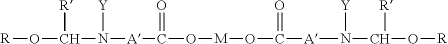

wherein each R, R′ and Y is defined as in claim 7; each A′ represents an alkylene group having 1 to 6 carbon atoms; and M represents a divalent metal ion.

Preferably R represents a multivalent substituted hydrocarbyl group linking two or more

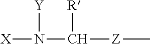

groups; Y represents a hydrocarbyl or substituted hydrocarbyl group having 1 to 20 carbon atoms; and none of X, Y, and R′ is a multivalent substituted hydrocarbyl group linking two or more

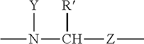

moieties.

Preferably, the compound (II) has the formula Q(-OC(O)-(Az)-J)ₓ wherein x=2 to 6; and Q is the residue of a polyol having at least x hydroxyl groups.

Preferably, the compound (II) has the formula M(-OC(O)-(Az)-J)₂wherein M represents a divalent metal ion.

Preferably the carbon based filler comprises carbon fibres.

Preferably, the carbon based filler is carbon black.

Preferably, the carbon based filler is selected from carbon nanotubes, fullerene, graphene and expandable graphene.

The carbon based filler and the compound (I) or compound (II) are preferably mixed at a temperature of 0 to 120° C. and are compounded with a polymeric material at a temperature of 120 to 200° C. to improve the adhesion of the carbon based filler to the polymeric material.

The polymeric material preferably contains carbon-to-carbon unsaturation and has been treated with a compound (I) or compound (II).

The invention extends to the use of a compound (I) containing in its molecule at least two moieties of the formula

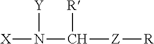

wherein X represents a hydrocarbyl or substituted hydrocarbyl group having 1 to 20 carbon atoms; Y represents hydrogen or a hydrocarbyl or substituted hydrocarbyl group having 1 to 20 carbon atoms; R′ represents hydrogen or a hydrocarbyl or substituted hydrocarbyl group having 1 to 20 carbon atoms; Z represents oxygen or sulphur; and R represents a hydrocarbyl or substituted hydrocarbyl group having 1 to 20 carbon atoms, at least one of the groups X and R being a multivalent substituted hydrocarbyl group linking two or more

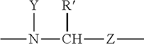

moieties; as an agent for modifying the surface of a carbon based filler to improve the adhesion of the filler to hydrocarbon polymers.

The compound (I) is preferably a substituted piperazine of the formula [R—Z—(CHR′-Pip-CHR′—Z—R″—Z)ₙ—CH2-Pip-CH2-Z]ₘ—R*, where each R represents a hydrocarbyl or substituted hydrocarbyl group having 1 to 20 carbon atoms; each R′ represents hydrogen or a hydrocarbyl or substituted hydrocarbyl group having 1 to 8 carbon atoms; Pip represents an optionally substituted piperazine ring bonded through its nitrogen atoms; each Z represents an oxygen or sulphur atom; R″ represents an alkylene, hydroxyalkylene, thioalkylene or polyoxyalkylene linkage having 2 to 20 carbon atoms or an alkylene, hydroxyalkylene, thioalkylene or polyoxyalkylene linkage having 2 to 20 carbon atoms substituted by 1 to 4 R—Z—CHR′-Pip-CHR′-Z— groups, where R, R′, Z and Pip are defined as above; n=0 to 20; m=1 to 6; and R* is the residue of an alcohol, thiol, polyol or polythiol having at least m hydroxyl or thiol groups.

The invention provides the use of a compound (II) containing in its molecule at least two moieties of the formula —OC(O)-(Az)-J wherein Az represents an aziridine ring bonded to the group J through its nitrogen atom; and J represents a hydrocarbyl or substituted hydrocarbyl group having 1 to 20 carbon atoms; as an agent for modifying the surface of a carbon based filler to improve the adhesion or coupling of the filler to hydrocarbon polymer, elastomer, thermoset, fluorocarbon polymer, silyl containing (co)polymer or silicone polymer.

The invention extends to a carbon based filler modified by treatment with a process described above.

The invention provides a filled polymer composition comprising an organosilicon polymer and a modified carbon based filler as defined above.

The invention provides a filled polymer composition comprising a polymer, a modified carbon based filler as defined above and any other type of filler or fibre.

N-N′(ethoxymethyl)piperazine was prepared following the article in Russian Journal of Applied Chemistry; Volume 82, Issue 5, Pages 928-930; Journal 2009; by V. M. Farzaliev, M. T. Abbasova, A. A. Ashurova, G. B. Babaeva, N. 15 P. Ladokhina and Ya. M. Kerimova which describes the preparation of bis(alkoxymethyl)piperazines by condensation of piperazine with formaldehyde and aliphatic alcohols.

In example 1 and comparative example 1 to 3 the following material were used:
Molecule 1—N,N′-(ethoxy-methyl)-piperazine
Molecule 2—Sarcozyne from Sigma Aldrich
p-H2CO—para-formaldehyde from Sigma Aldrich
CNT—Multiwall carbon nanotube from Nanocyl company—Nanocyl™ NC 7000

All examples were made using the following treatment procedure

To allow good deposition of silane and non silane molecule on the surface of the CNTs, a dispersion in ethanol was prepared—for 1 g of CNT 40 ml of absolute ethanol was used. After dispersion of CNT, silane and if necessary p-H2CO were added. The solution was stirred for 2 hours at room temperature. After stirring, Ethanol was removed using a rotavapor with a temperature of 50° C. under vacuum. Dried CNT with silane and when present p-H2CO deposit on the surface were heated up in a ventilated oven at 210° C. for time of 2 or 6 hours to optimize deposit on the CNT surface. Treated CNT were then washed using ethanol (70 ml of ethanol for 5 g of treated CNT) to wash out non reacted material. Washed and heat treated CNT were then dried using a rotavapor with a temperature of 50° C. under vacuum to remove traces of ethanol. The obtained samples were then analysed by TGA to detect residual material on the surface and to quantify grafted material.

### TGA Equipment:

Instrument: TGA851/SDTA (Mettler-Toledo), Alumina pan 150 ul, nitrogen & air flow (100 ml/min).

A background of an empty Alumina pan was recorded in the same conditions and subtracted to the TGA of each sample (baseline correction).

### TGA Procedure:

25° C. for 2 min under N2
Ramp from 25° C. to 650° C. 10° C./min under N2
Cooling to 550° C. under N2
2 min at 550° C. switch to air
Ramp to 1000° C. at 10° C./min under air

The quantification of the deposited product was based on weight loss between 150° C. to 650° C. pure CNT weight loss was substracted to quantify residue from treating agent only.

Mole of product was determined using the following equation:

Product mol reacted on CNT surface for 100 g of analysed grafted CNT=corrected weight loss 150-650° C.(%)/(28*Functionality)

Where 28 is the Nitrogen molecular weight and functionality is the number of Si atom for each silane molecule. Functionality was ½ for sarcozyne and 1 for diethoxypiperazine.

Example 1 was made using molecule 1 and CNT
Comparative example C1 was made using molecule, 5 equivalent of p-H2CO and CNT
Comparative example C2 was pure CNT reference product
Comparative example C3 was CNT following all treatment procedure to understand impact of treatment procedure on CNT.

TABLE 1

| | | | Optimal |
|---|---|---|---|
| | | | Treatment |
| | | Quantities of | procedure |
| | | material | found (hr/ |
| example | Molecule(s) | (g) | temperature) |
| 1 | N,N′- | CNT: 8 | 2 hrs/210° C. |
| | diethoxymethylpiperazine | Silane: 4.6 | |
| C1 | Sarcozyne + p-H2CO | CNT: 5 | 1 hrs/210° C. |
| | | Sarcozyne: 1.25 | |
| | | p-H2CO: 0.42 | |

TABLE 2

| | Organic specied loss | | |
|---|---|---|---|
| | 150-650° C. and under | Corrected organic | |
| example | cooling (weight %) | species loss (%) | Mol % |
| 1 | 5.63 + 6.89 | 6.35 | 0.227 |
| C1 | 4.0 + 5.17 | 3.00 | 0.214 |
| C2 | 2.32 + 3.85 | — | — |
| C3 | 2.13 + 3.24 | — | — |

Example showed a similar grafting level as compared to Comparative example 1 showing good ability of N,N′-diethoxy-methyl-piperazine molecule to graft to MWCNT. Treatment is saturating at 6 hours and about 95% of grafting efficiency probably due to evaporation of molecule during heat treatment.

1. A process for modifying the surface of a carbon based filler, characterised in that the carbon based filler is treated with a compound (I) containing in its molecule at least two moieties of the formula 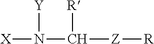
wherein X represents a hydrocarbyl or substituted hydrocarbyl group having 1 to 20 carbon atoms; Y represents hydrogen or a hydrocarbyl or substituted hydrocarbyl group having 1 to 20 carbon atoms; R′ represents hydrogen or a hydrocarbyl or substituted hydrocarbyl group having 1 to 20 carbon atoms; Z represents oxygen or sulphur; and R represents a hydrocarbyl or substituted hydrocarbyl group having 1 to 20 carbon atoms, at least one of the groups X and R being a multivalent substituted hydrocarbyl group linking two or more 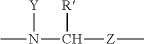
Moieties, or with a compound (II) containing in its molecule at least two moieties of the formula —OC(O)-(Az)-J wherein Az represents an aziridine ring bonded to the group J through its nitrogen atom; and J represents a hydrocarbyl or substituted hydrocarbyl group having 1 to 20 carbon atoms
or with a mixture thereof.

2. A process according to claim 1, characterised in that the groups X and Y are both substituted hydrocarbyl groups linking the same two 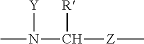
moieties to form a piperazine ring.

3. A process according to claim 2, characterised in that the compound (I) is a substituted piperazine of the formula [R—Z—(CHR′-Pip-CHR′—Z—R″—Z)ₙ—CH₂—Pip—CH₂—Z)ₘ—R*, where each R represents a hydrocarbyl or substituted hydrocarbyl group having 1 to 20 carbon atoms; each R′ represents hydrogen or a hydrocarbyl or substituted hydrocarbyl group having 1 to 8 carbon atoms; Pip represents an optionally substituted piperazine ring bonded through its nitrogen atoms; each Z represents an oxygen or sulphur atom; R″ represents an alkylene, hydroxyalkylene, thioalkylene or polyoxyalkylene linkage having 2 to 20 carbon atoms or an alkylene, hydroxyalkylene, thioalkylene or polyoxyalkylene linkage having 2 to 20 carbon atoms substituted by 1 to 4 R—Z—CHR′-Pip-CHR′—Z— groups, where R, R′, Z and Pip are defined as above; n=0 to 20; m=1 to 6; and R* is the residue of an alcohol, thiol, polyol or polythiol having at least m hydroxyl or thiol groups.

4. A process according to claim 3, characterised in that n=0, m=1, each atom Z in the substituted piperazine represents an oxygen atom and each group R represents a hydrocarbyl group having 1 to 8 carbon atoms.

5. A process according to claim 4, characterised in that R* represents the residue of a polyol selected from ethylene glycol, propylene glycol, 1,4-butanediol, trimethylolpropane and pentaerythritol.

6. A process according to claim 1, characterised in that X represents a multivalent substituted hydrocarbyl group linking two or more 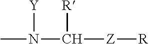
groups; Y represents a hydrocarbyl or substituted hydrocarbyl group having 1 to 20 carbon atoms; Z represents oxygen; and none of Y, R and R′ is a multivalent substituted hydrocarbyl group linking two or more 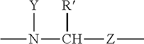
moieties.

7. A process according to claim 6, characterised in that the compound (I) has the formula 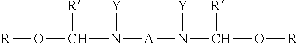
wherein each R, R′ and Y is defined as in claim 6 and A represents a divalent organic group having 2 to 20 carbon atoms.

8. A process according to claim 6, characterised in that the compound (I) has the formula 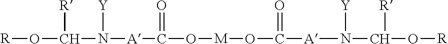
wherein each R, R′ and Y is defined as in claim 6; each A′ represents an alkylene group having 1 to 6 carbon atoms; and M represents a divalent metal ion.

9. A process according to claim 1, characterised in that R represents a multivalent substituted hydrocarbyl group linking two or more 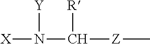
groups; Y represents a hydrocarbyl or substituted hydrocarbyl group having 1 to 20 carbon atoms; and none of X, Y, and R′ is a multivalent substituted hydrocarbyl group linking two or more 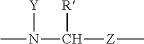
moieties.

10. A process according to claim 1, characterised in that the compound (II) has the formula Q(-OC(O)-(Az)-J)ₓ wherein x=2 to 6; and Q is the residue of a polyol having at least x hydroxyl groups.

11. A process according to claim 11, characterised in that the compound (II) has the formula M(-OC(O)-(Az)-J)₂ wherein M represents a divalent metal ion.

12. A process according to claim 1, wherein the carbon based filler comprises carbon fibres.

13. A process according to claim 1, wherein the carbon based filler is carbon black.

14. A process according to claim 1 any, wherein the carbon based filler is selected from carbon nanotubes, fullerene, graphene and expandable graphene.

15. A process according to claim 1 wherein the carbon based filler and the compound (I) or compound (II) are mixed at a temperature of 0 to 120° C. and are compounded with a polymeric material at a temperature of 120 to 200° C. to improve the adhesion of the carbon based filler to the polymeric material.

16. A process according to claim 15 wherein the polymeric material contains carbon-to-carbon unsaturation and has been treated with a compound (I) or compound (II).

17-19. (canceled)

20. A carbon based filler modified by treatment with a process according to claim 1.

21. A filled polymer composition comprising an organosilicon polymer and a modified carbon based filler as defined in claim 20.

22. A filled polymer composition comprising a polymer, a modified carbon based filler as defined in claim 20 and any other type of filler or fibre.
